(19) United States
(12) Patent Application Publication
(10) Pub. No.: US 2007/0047774 A1
(43) Pub. Date: Mar. 1, 2007

(54) Method and apparatus for performing enrollment of 2D and 3D face biometrics

(76) Inventors: Artiom Yukhin, Moscow (RU); Andrey Klimov, Moscow (RU); Sergey Suhovey, Moscow (RU)

Correspondence Address: FENWICK & WEST LLP, SILICON VALLEY CENTER, 801 CALIFORNIA STREET, MOUNTAIN VIEW, CA, 94041, US

(21) Appl. No.: 11/254,220

(22) Filed: Oct. 18, 2005

Related U.S. Application Data
(60) Provisional application No. 60/713,239, filed on Aug. 31, 2005.

(51) Int. Cl. G06K 9/00

(52) U.S. Cl. 382/118

(57) ABSTRACT

A device for performing enrollment of 2D and 3D face biometrics captures an image of a pattern projected on an object, such as a human face, and distorted on the 3D surface and an image of a two-dimensional (2D) surface of the object. These images can be used for identification and facial recognition of the object.

### CROSS-REFERENCE TO RELATED APPLICATION

This application claims the benefit of U.S. Provisional Application No. 60/713,239, entitled “Apparatus For Performing Enrollment of Users' 2D and 3D Face Biometrics For Biometric Control Applications”, filed Aug. 31, 2005, which is incorporated by reference herein in its entirety.

### FIELD OF INVENTION

The present invention relates to the field of face recognition, and more particularly, to the enrollment of face biometrics.

### BACKGROUND OF THE INVENTION

Biometric identification systems that do not require a target's cooperation are enjoying great popularity and demand among governmental authorities and companies where security is of importance, such as airports, banks, workplaces and other secure or restricted places. For instance, systems employing biometric facial recognition, unlike security systems that require target cooperation (e.g., fingerprint recognition, iris recognition, etc.), require no human cooperation, awareness, or contact. These systems can work passively at a distance in real time environment.

Conventional systems and methods for biometric facial recognition typically use 2D images of a person's face, similar to images received from video or photo cameras. Although 2D image data is easy to collect, it is not uniquely distinctive and the quality of the acquired data depends from various factors, such as ambient light conditions, view angle, etc. Consequently, the reliability of 2D biometric facial recognition systems lags behind many conventional security systems that use biometric data, such as fingerprints, retinal eye patterns, or hand geometry, to identify a person. Some conventional systems that are only capable of capturing 2D image data experience difficulty in isolating a target image, such as a person's face, from other objects. These systems also experience accuracy problems because the quality of the acquired data is negatively affected by shadows or movement by the person or object to be identified.

3D images, in contrast, are not negatively affected by any movement of the object to be identified and do not depend on the texture and color of the skin. Since 3D images carry more information about the object than 2D images, it is desirable to use 3D images in biometric identification systems. In addition, it is desirable to have a system that simultaneously captures an image of a pattern projected on an object and distorted on the three-dimensional (3D) surface and a 2D photographic image of the object that can be used for passport, driver licenses, and other identification documents.

### SUMMARY OF THE INVENTION

A device for performing enrollment of 2D and 3D face biometrics captures an image of a pattern projected on an object, such as a human face, and distorted on the 3D surface and an image of a two-dimensional (2D) surface of the object. These images can be used for identification and facial recognition of the object.

In one embodiment, the device comprises an illumination unit adapted to project a patterned light onto the surface of the object, a 3D image capturing device adapted to capture an image of a pattern projected on the object and distorted on the 3D surface. The device also includes a 2D image capturing device adapted to capture an image of a 2D frontal view of the object. Alternatively, the 2D image capturing device is part of the 3D image capturing device so that the 3D image capturing device is adapted to capture an image of a 2D view of the object and an image of a pattern projected on the object and distorted on the 3D surface. The device can also include an orientation unit, such as a Liquid Crystal Display (LCD), plasma screen, or any other device adapted to display the object's face.

In one embodiment, the device for enrollment of 2D and 3D face biometrics is adapted to comply with the International Civil Aviation Organization (ICAO) standard with respect to scene constraints (pose, expression, etc.), photographic properties (lighting, positioning, camera focus, etc.), digital image attributes (image resolution, image size, etc.), as well as a data format. To ensure that the object is in the field of view of the 3D image capturing device and the illumination unit and a frontal view of the object is captured, a height-adjusting mechanism is connected to the enrollment device. An operator uses the height-adjusting mechanism to manually adjust the height of the device for enrollment of face biometrics by looking on a 2D image of the object displayed at a computer system connected to the device. As a result, the object is in the field of view of the 2D image capturing device, the 3D image capturing device, and the illumination unit. According to another embodiment, the device is adjusted automatically.

The ICAO standard further states that the 2D image capturing device should capture 2D images of an object within a certain distance from the object (e.g., within the range of 1.2 and 2 meters). To address this, the device for enrollment of face biometrics may include a reflecting surface. The reflecting surface is adapted to refract optical axis of the 2D image capturing device as is known in the art. This technique is used to provide dimension reduction of the 2D image capturing device. As a result, when the 2D image capturing device captures a 2D image of the object, the 2D image capturing device is within the ICAO distance from the object.

In another embodiment, the orientation unit is used to position the object to ensure that the object is in the fields of view of 2D image capturing device 185, illumination unit 120, and 3D image capturing device 140. In this embodiment, a translucent surface is positioned between the 2D image capturing device and the orientation unit. The translucent surface can be a mirror or any other device that partially reflects light and partially passes the light. The translucent surface is adapted to refract optical axis of the 2D image capturing and transmit optical axis of the orientation unit.

The features and advantages described in this summary and the following detailed description are not all-inclusive. Many additional features and advantages will be apparent to one of ordinary skill in the art in view of the drawings and specification. Moreover, it should be noted that the language used in this disclosure has been principally selected for readability and instructional purposes, and may not have been selected to delineate or circumscribe the inventive subject matter, resort to the claims being necessary to determine such inventive subject matter.

### BRIEF DESCRIPTION OF THE DRAWINGS

FIG. 1 is a side view of an enrollment device that performs enrollment of 2D and 3D face biometrics according to an embodiment of the present invention.

FIG. 2 is a block diagram of the components of an enrollment device according to one embodiment of the present invention.

FIG. 3 is an exemplary image of a pattern projected on an object and distorted on the 3D surface according to one embodiment of the present invention.

FIG. 4 is a block diagram of an illumination unit according to one embodiment of the present invention.

FIG. 5 is a block diagram of a 2D image capturing device and 3D image capturing device adapted to perform simultaneous capture of a 2D image and an image of a pattern projected on an object and distorted on the 3D surface according to one embodiment of the present invention.

FIG. 6 is a block diagram of the components of an enrollment device according to another embodiment of the present invention.

### DETAILED DESCRIPTION OF THE EMBODIMENTS

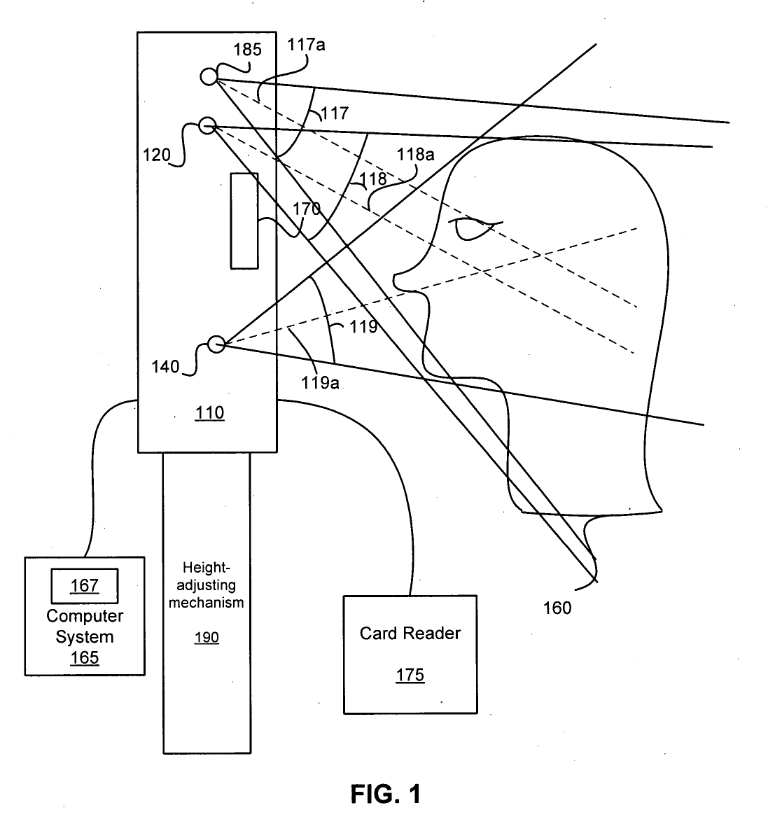

FIG. 1 is a side view of the enrollment device 110 adapted to perform enrollment of 2D and 3D face biometrics according to an embodiment of the present invention. Illumination unit 120 projects a patterned light on object 160, such as a human face, in an invisible electromagnetic range. A 3D image capturing device 140 is adapted to capture an image of a pattern projected on the object 160 and distorted on the 3D surface. The 2D image capturing device 185 captures an image of a 2D view of the object 160 in visible electromagnetic range, e.g., electromagnetic waves that a human eye can see. A person of ordinary skill in the art would understand that 2D image capturing device 185 can capture an image of a 2D view of object 160 in other electromagnetic ranges. 2D photographic images are used in identification documents, such as driver licenses, as well as in biometric control. 2D image capturing device 185 can be in compliance with the standard imposed by the International Civil Aviation Organization (ICAO) for creating photographic images (e.g., Biometric Data Interchange Formats—Part 5: Face Image Data, ISO/IEC CD 19794-5, ISO/IEC JTC 1/SC 37 N 506, 2004-03-22) and/or other standards for creating photographic images.

In one embodiment, device 110 is connected to a height-adjusting mechanism 190 adapted to adjust the height of the device 110 relative to the height of object 160. An operator (not shown) of mechanism 190 can see a 2D image of object 160 at a monitor of computer system 165 connected to device 110. The operator manually adjusts the height of device 110 to ensure that object 160 is in the fields of view 117, 118, and 119 of 2D image capturing device 185, illumination unit 120, and 3D image capturing device 140, respectively. In this embodiment, orientation unit 170 is not used to perform enrollment of face biometrics. In another implementation, device 110 does not include orientation unit 170. In yet another embodiment, device 110 can be adjusted automatically so that object 160 is in the fields of view 117, 118, and 119 of 2D image capturing device 185, illumination unit 120, and 3D image capturing device 140, respectively.

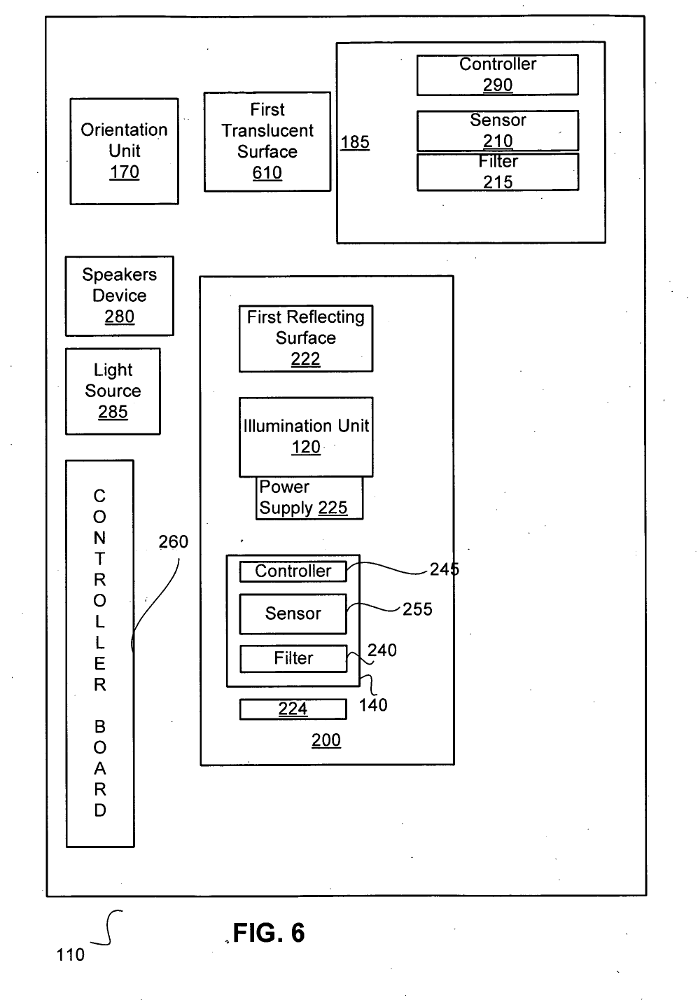

In another embodiment, orientation unit 170 is positioned behind a first translucent surface 610 (shown in FIG. 6) so that object 160 is in the fields of view 117, 118, and 119 of 2D image capturing device 185, illumination unit 120, and 3D image capturing device 140. The translucent surface 610 is positioned between orientation unit 170 and 2D image capturing device 185. This embodiment is described in greater detail in reference to FIG. 6.

Computer system 165 is adapted to receive an image of a pattern projected on an object 160 and distorted on the 3D surface of the object from device 110 and to process the image to reconstruct a 3D image of the object 160. Computer system 165 can be a general-purpose computer, a personal digital assistant (PDA), or any other computer system having a processor (not shown in FIG. 1). Device 110 can be connected to computer system 165 via various interfaces, e.g., wireless, wired, or any other connection. Computer system 165 also maintains a data store 167 for storing face biometrics.

Device 110 can also be connected to a card reader 175. Card reader 175 is adapted to read the contents of a card presented by object 160 that includes object's 160 identification information. Card reader 175 is adapted to transmit this information to computer system 165. Computer system 165, in turn, uses the received information to perform identification and recognition of object 160. Device 110 is connected to card reader 175 via various interfaces (e.g., wired, wireless, or any other connection).

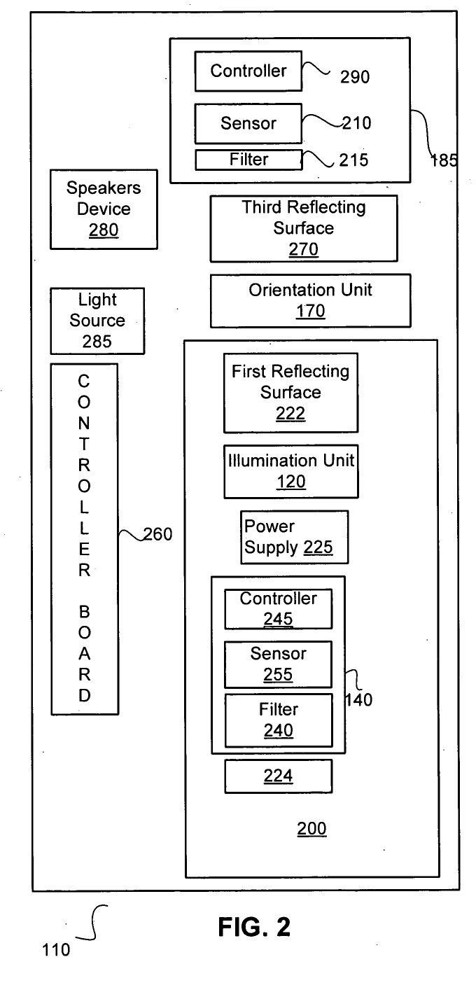

FIG. 2 is a block diagram of the components of the enrollment device 110 according to one embodiment of the present invention. Device 110 includes an optical unit 200, the 2D image capturing device 185, the orientation unit 170, a speaker's device 280, a lighting source 285, a controller board 260, and a third reflecting surface 270. The optical unit 200 comprises the illumination unit 120 coupled to a power supply unit 225, the 3D image capturing device 140, a first reflecting surface 222, and a second reflecting surface 224. These components are described in greater detail below.

The illumination unit 120 is adapted to project light on the object 160 as shown in FIG. 1. The illumination unit 120 can be any suitable light-emitting device, such as, for example, a laser, a projector, or any other device emitting light in an invisible electromagnetic range. A person of ordinary skill in the art would understand that illumination unit 120 can emit light in other electromagnetic ranges. In one embodiment of the present invention, illumination unit 120 is adapted to project a patterned light, e.g., stripes, a grid, or any other pattern. In another embodiment, illumination unit 120 is adapted to project light onto object 160 evenly.

A first reflecting surface 222 is adapted to refract optical axis 118a of illumination unit 120 as is known in the art. This technique is used to provide dimension reduction of optical unit 200. The first reflecting surface 222 is positioned above the illumination unit 120 at an angle. The second reflecting surface 224 is adapted to refract optical axis 119a of 3D image capturing device 140. The second reflecting surface 224 is positioned underneath the 3D image capturing device 140.

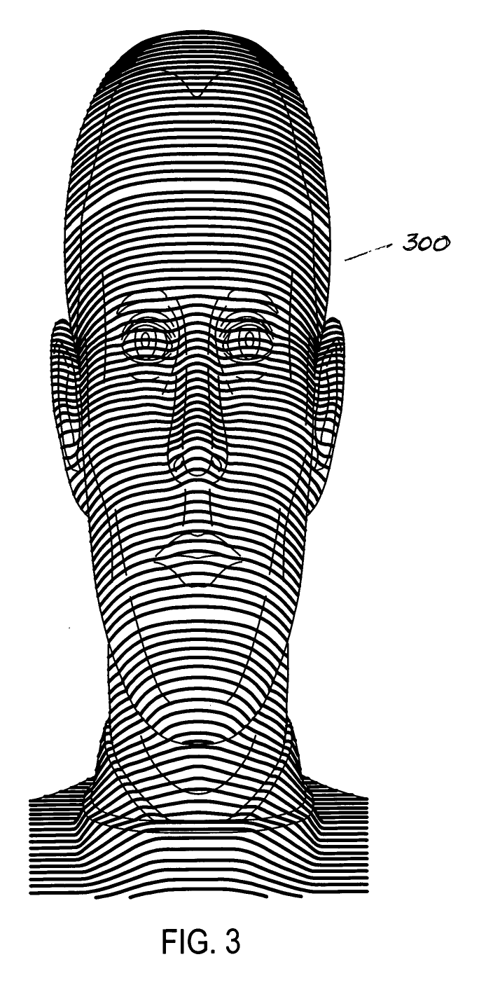

In one embodiment of the present invention, a “structured lighting” principle is used to capture an image of a pattern projected on the object 160 and distorted on the 3D surface of the object. A structured lighting is a front-lighting technique used to extract surface features from 3D objects and to reconstruct geometry of an object's surface. In a structured lighting, a light pattern, such as a line, grid, or any other pattern, is projected onto object 160 at a known angle using a light source, such as, for example, illumination unit 120. The light pattern intersects with an object and is reflected according to the contours of the object 160. Turning now to FIG. 3, it illustrates an exemplary image 300 of a pattern projected on object 160 and distorted on the 3D surface according to one embodiment of the present invention. The distorted pattern contains information needed to reconstruct all three coordinates (X, Y, and Z) of all points belonging to the face's surface. 3D image capturing device 140 records the distorted pattern.

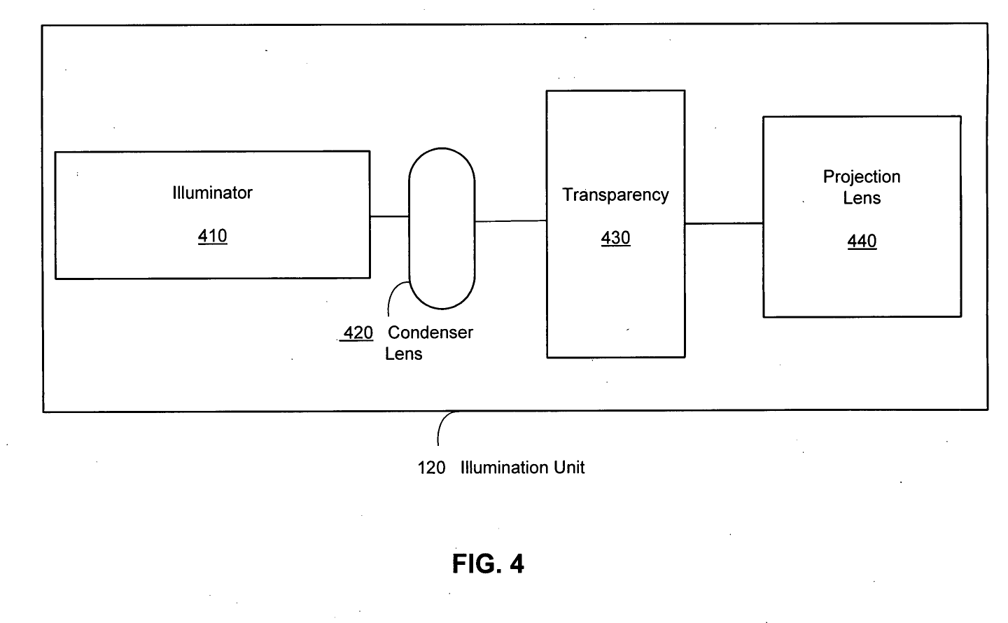

Referring now to FIG. 4, a block diagram of the illumination unit is shown according to one embodiment of the present invention. The illumination unit 120 comprises an illuminator 410, condenser lens 420, a transparency 430, and projection lens 440. The illuminator 410 and condenser lens 420 are adapted to optimize lighting projected on the transparency 430. The transparency 430 is a slide pattern that is projected onto the object 160 by illumination unit 120. In one embodiment, the transparency 430 includes aperiodic horizontal stripes. In this embodiment, the width of the stripes may not be the same, and the distance between any two stripes may not be the same. Projecting the transparency image with aperiodic stripes is advantageous because it increases the accuracy of the process of restoration of a 3D image. A person of ordinary skill in the art will understand though that the transparency 430 may include periodic horizontal stripes, a grid, or any other pattern. The projection lens 440 is adapted to project the image of the transparency 430 on the object 160 in different spectral ranges of electromagnetic radiation.

Referring again to FIG. 2, 3D image capturing device 140 is adapted to capture an image of a pattern projected on the object 160 and distorted on the 3D surface. The 3D image capturing device 140 captures an image in invisible light. A person of ordinary skill in the art would understand that 3D image capturing device 140 can capture an image of a pattern projected on the object 160 and distorted on the 3D surface in other electromagnetic ranges. The 3D image capturing device 140 can be a grey scale video camera, such as SanKwang 10004X video camera that is commercially available from SanKwang, Inc. of Seoul, South Korea. The 3D image capturing device 140 also includes a sensor 255, a filter 240, and a controller unit 245.

Sensor 255 is adapted to transform an optical signal received by device 140 to an analog electrical signal. Controller unit 245 is adapted to receive the analog signal from sensor 255 and transform the signal into a composite TV signal.

Filter 240 is adapted to allow 3D image capturing device 140 to capture an image in an invisible electromagnetic range. In one embodiment, device 140 captures a distorted image at the same electromagnetic range that the illumination unit 120 projects light on the object 160. For example, if the illumination unit 120 projects light at the wavelength of 785 nanometers, the 3D image capturing image 140 captures an image at the same wavelength. Filter 240 can be a band-pass filter, such as Intor 758/10/75 that is commercially available from Intor, Inc., of Socorro, N. Mex., United States.

The 2D image capturing device 185 is adapted to capture an image of a 2D view of the object 160. In one embodiment, the image is consistent with the International Civil Aviation Organization (ICAO) standard for creating photographic images and/or other standards for creating photographic images. In one embodiment, 2D image capturing device 185 is adapted to meet the ICAO standard with respect to scene constraints (pose, expression, etc.), photographic properties (lighting, positioning, camera focus, etc.), digital image attributes (image resolution, image size, etc.), as well as a data format. For example, consistent with the ICAO standard, the 2D image capturing device 185 should capture a 2D image of a frontal view of object 160. Thus, object 160 is positioned in front of 2D image capturing device 160 so that 2D image capturing device 185 captures a frontal view of object 160. The ICAO standard further states that 2D image capturing device 185 captures 2D images within a certain distance from object 160 (e.g., within the range of 1.2 and 2 meters).

To address these goals and other goals, including having object 160 that is in the field of view of the 3D image capturing device 140 and the illumination unit 140 and capturing a frontal view of object 160, a height-adjusting mechanism 190 is connected to device 110. An operator (not shown) of device 110 uses mechanism 190 to manually adjust the height of device 110 by looking on a 2D image of object 160 displayed at computer system 165 connected to device 110. Device 110 can be vertically positioned on a horizontal surface, such as a table. The operator manually adjusts the height of device 110 to ensure that object 160 is in the field of view of 2D image capturing device 185, 3D image capturing device 140, and illumination unit 120. In another embodiment, this adjustment can be done automatically.

As was previously described, the ICAO standard further states that 2D image capturing device 185 captures 2D images of an object within a certain distance from object 160 (e.g., within the range of 1.2 and 2 meters). To address this, device 110 may include a third reflecting surface 270. Third reflecting surface 270 is adapted to refract optical axis 117a of 2D image capturing device 185 as is known in the art. This technique is used to provide dimension reduction of 2D image capturing device 185. As a result, 2D image capturing device 185 captures a 2D image of object 160 within the ICAO range from object 160 so that device 110 is consistent with the ICAO standard with respect to the distance between 2D image capturing device 185 and object 160.

The output of 2D image capturing device 185 is a sequence of 2D color images that can be used in passports, driver licenses, and other identification documents, as well as in biometric control. The 2D image capturing device 185 can be any progressive scan color video or photographic camera adapted to capture 2D color images according to the ICAO standard or other standards for creating photographic images. 2D image capturing device 185 can have a minimum resolution of 640×480 pixels. Examples of progress scan color video or photographic cameras are UI-1540 that is commercially available from Net GmbH, of Finning, Germany, and EHDcmos2.0 that is commercially available from EHD Imaging GmbH, of Dammer, Germany.

2D image capturing device 185 also includes a sensor 210, a controller unit 290, and a filter 215. Sensor 210 is adapted to transform an optical signal received by device 185 to an analog electrical signal. Controller unit 290 is adapted to receive the analog signal from sensor 210 and transform the signal into a composite TV signal. Filter 215 is adapted to allow device 185 to see object 160 in a visible electromagnetic range and not to see light emitted by illumination unit 120. A person of ordinary skill in the art would understand that 2D image capturing device 185 can capture images in other electromagnetic ranges.

In another embodiment, the 2D image capturing device 185 is part of the 3D image capturing device 140. In this embodiment, the 3D image capturing device 140 is adapted to capture an image of a pattern projected on an object and distorted on the 3D surface of the object of object 160 and to capture an image of the 2D frontal view of the object 160 and output 2D color images.

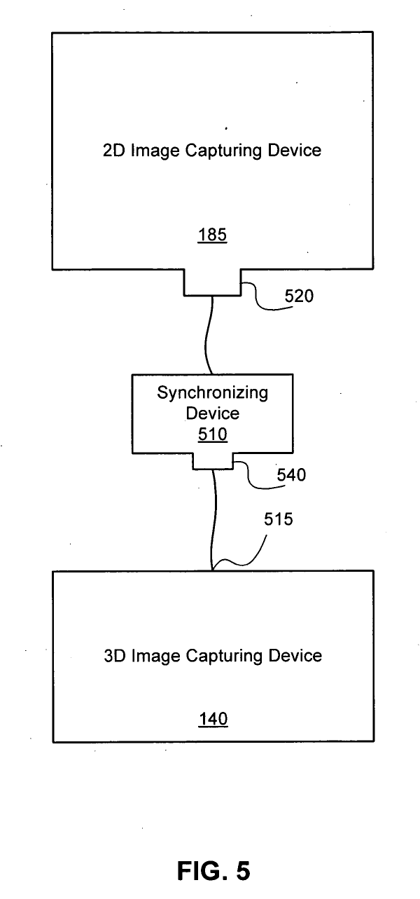

In yet another embodiment, 2D image capturing device 185 captures a 2D color image of object 160 simultaneously with 3D image capturing device 140 capturing an image of a pattern projected on the object 160 and distorted on the 3D surface of the object 160. Turning now to FIG. 5, a block diagram of 2D image capturing device 185 and 3D image capturing device 140 connected to perform simultaneous capture of images according to one embodiment of the present invention is shown. In FIG. 5, a synchronizing device 510 is connected to a sync input 520 of 2D image capturing device 185. 3D image capturing device 140, in turn, is connected with its output 515 to the input 540 of the synchronizing device 510. This allows device 185 and device 140 to capture images simultaneously.

Device 110 further includes a controller board 260, speaker's device 280, and a light source 285. Light source 285 is adapted to emit visible light that can be used, for example, to communicate to object 160 whether access to a secured area is granted. Light source 285 can emit light in other frequencies. Light source 285 can be, for example, a light emitting diod (LED). Speaker's device 280 is adapted to convert an electrical signal into a sound. The sound can be used, for example, to communicate to object 160 whether access to a secured area is granted.

Controller board 260 is adapted to act as an intermediary between computer system 165 and peripheral devices, such as the card reader 175, door access control (not shown), and any other peripheral device connected to device 110. In addition, controller board 260 is adapted to control speaker's device 280 and light source 285.

Referring now to FIG. 6, a block diagram of the components of device 110 is shown according to another embodiment of the present invention. The components of device 110 have been discussed above in reference to FIG. 2. The following are the differences between the embodiments shown in FIG. 2 and in FIG. 6. In the embodiment illustrated in FIG. 6, a first translucent surface 610 is positioned between 2D image capturing device 185 and orientation unit 170. Translucent surface 610 can be a mirror or any other surface that partially reflects light and partially passes the light. Translucent surface 610 is adapted to refract optical axis 117a of 2D image capturing device 185 and transmit optical axis (not shown) of orientation unit 170 as is known in the art. Orientation unit 170 is positioned behind the first translucent surface 610. 2D image capturing device 185 can see object 160 through translucent surface 610 in reflected light. Object 160 is positioned in front of orientation unit 170 that can be seen through translucent surface 610 in direct light. When 2D image capturing device 185 captures a 2D image of object 160, the captured image is displayed on orientation unit 170. As a result, object 160 is in the field of view 117 of 2D image capturing device 185 and at the same time can see his or her 2D image on orientation unit 170. The displayed image is used as a feedback for self-positioning. 2D image capturing device 185 is within the ICAO range from object 160 so that device 110 is in compliance with the ICAO or any other standard for creating photographic images with respect to the distance between 2D image capturing device 185 and object 160.

Orientation unit 170 can be a plasma screen, a liquid crystal display (LCD), or any other surface adapted to display the object's 160 face. Orientation unit 170 may include indicators that help object 160 to position himself or herself to be in the field of view 117 of 2D image capturing device 185 in compliance with the ICAO or any other standard for creating photographic images. These indicators can be positioned along the edges of orientation unit 170 and guide the object 160 to choose the best position so that the object 160 is in the field of view 117 of 2D image capturing device 185. Other indicators, such as lines, may be used for eyes and nose positioning.

This embodiment advantageously allows device 110 to take a 2D image of a frontal view of object 160 in accordance with the ICAO or other similar standards and to capture an image of a pattern projected on the object 160 and distorted on the 3D surface. In addition, object 160 can see, on the orientation unit 170, its 2D frontal image captured by 2D capturing device 185.

The present invention has been described in particular detail with respect several embodiments. Those of skill in the art will appreciate that the invention may be practiced in other embodiments. First, the particular naming of the components, capitalization of terms, the attributes, data structures, or any other programming or structural aspect is not mandatory or significant, and the mechanisms that implement the invention or its features may have different names, formats, or protocols. Further, the system may be implemented via a combination of hardware and software, as described, or entirely in hardware elements. Also, the particular division of functionality between the various system components described herein is merely exemplary, and not mandatory; functions performed by a single system component may instead be performed by multiple components, and functions performed by multiple components may instead performed by a single component.

What is claimed is:

1. A device for performing enrollment of an object's two-dimensional and three-dimensional face biometrics, the device comprising:
an illumination unit adapted to project patterned light on the object;
a first image capturing device adapted to capture an image of a pattern projected on the object and distorted on a three-dimensional surface; and
a second image capturing device adapted to capture an image of a two-dimensional view of the object.

2. The device of claim 1, wherein the illumination unit has a field of view, the first image capturing device has a field of view, and the second image capturing device has a field of view, further comprising:
a height-adjusting mechanism adapted to adjust height of the device so that the object is in the field of view of the illumination unit, in the field of view of the first image capturing device, and in the field of view of the second image capturing device.

3. The device of claim 1, wherein the second image capturing device is a color video camera adapted to capture an image of a two-dimensional view of the object consistent with an International Civil Aviation Organization (ICAO) standard.

4. The device of claim 1, wherein the second image capturing device is adapted to capture an image of a two-dimensional view of the object in visible light.

5. The device of claim 1, wherein the second image capturing device is a color photographic camera adapted to capture an image of a two-dimensional view of the object consistent with an International Civil Aviation Organization (ICAO) standard.

6. The device of claim 1, wherein the second image capturing device further comprises:
a sensor adapted to transform an optical signal received by the second image capturing device to an analog electrical signal;
a controller unit adapted to receive the analog electrical signal from the sensor and transform the signal into a composite TV signal; and
a filter adapted to enable the device to see the object in visible light.

7. The device of claim 1, wherein the first image capturing device adapted to capture an image of a pattern projected on the object and distorted on a three-dimensional surface and to capture an image of a two-dimensional view of the object.

8. The device of claim 1, wherein the first image capturing device is adapted to capture an image of a pattern projected on the object and distorted on the three-dimensional surface simultaneously with the second image capturing device adapted to capture an image of a two-dimensional view of the object.

9. The device of claim 1, wherein the first image capturing device is a grey scale video camera.

10. The device of claim 1, wherein the first image capturing device further comprises:
a sensor adapted to transform an optical signal received by the first image capturing device to an analog electrical signal;
a controller unit adapted to receive the analog electrical signal from the sensor and transform the signal into a composite TV signal; and
a filter adapted to enable the device to see the object in an invisible electromagnetic range.

11. The device of claim 1, wherein the first image capturing device is adapted to capture an image of a pattern projected on the object at the same electromagnetic wavelength that the illumination unit projects light onto the object.

12. The device of claim 1, further comprising:
a speaker's device adapted to convert an electrical signal into a sound;
a light source adapted to emit visible light; and
a controller board adapted to control the speaker's device and the light source.

13. The device of claim 1, wherein the illumination unit further comprises:
a transparency projected onto the object;
an illuminator adapted to optimize lighting projected on the transparency.

14. The device of claim 13, wherein the transparency includes aperiodic stripes.

15. The device of claim 13, wherein the transparency includes periodic stripes.

16. The device of claim 2, wherein the first image capturing device has an optical axis and wherein the device further comprises a first reflecting surface adapted to refract the optical axis of the first image capturing device to reduce dimension of the first image capturing device.

17. The device of claim 2, wherein the illumination unit has an optical axis and wherein the device further comprises a second reflecting surface adapted to refract the optical axis of the illumination unit to reduce dimension of the illumination unit.

18. The device of claim 1, wherein the second image capturing device has an optical axis and wherein the device further comprises a third reflecting surface adapted to refract the optical axis of the second image capturing device to reduce dimension of the second image capturing device.

19. A device for performing enrollment of an object's two-dimensional and three-dimensional facial biometrics, the device comprising:
an illumination unit having a field of view and adapted to project patterned light on the object in invisible light;
a first image capturing device having a field of view and adapted to capture an image of a pattern projected on the object and distorted on a three-dimensional surface of the object;
a second image capturing device having a field of view and adapted to capture an image of a two-dimensional view of the object;
a mechanism adapted to adjust height of the device so that the object is in the field of view of the illumination unit, the first image capturing device, and the second image capturing device; and
a third reflecting surface adapted to refract optical axis of the second image capturing device to reduce dimension of the second image capturing device so that the second image capturing device captures an image of a two-dimensional view of the object consistent with an ICAO standard.

20. A device for performing enrollment of an object's two-dimensional and three-dimensional face biometrics, the device comprising:
means for projecting patterned light on the object;
means for capturing an image of a pattern projected on the object and distorted on a three-dimensional surface; and
means for capturing an image of a two-dimensional view of the object.

21. A device for performing enrollment of two-dimensional and three-dimensional facial biometrics for biometric control applications, the device comprising:
an illumination unit adapted to project light on an object;
a first image capturing device adapted to capture an image of a pattern projected on the object and distorted on a three-dimensional surface of the object;
a second image capturing device adapted to see the object through a first translucent surface and to capture an image of a two-dimensional view of the object;
the first translucent surface positioned between the second image capturing device and an orientation unit, the first translucent surface adapted to refract optical axis of the second image capturing device as to reduce dimension of the second image capturing device; and
the orientation unit adapted to display the image of the two-dimensional view of the object so that the object is in the field of view of the second image capturing device.
